(19) United States
(12) Patent Application Publication
(10) Pub. No.: US 2024/0232620 A1
(43) Pub. Date: Jul. 11, 2024

(54) ARTIFICIAL INTELLIGENCE DEVICE FOR EVALUATION AND CONTROL METHOD THEREOF

(71) Applicant: LG ELECTRONICS INC., Seoul (KR)

(72) Inventors: Harmanpreet SINGH, Toronto (CA); Maxime GAZEAU, Toronto (CA); Homa FASHANDI, Toronto (CA); Royaldenzil SEQUIERA, Kitchener (CA); Sen JIA, Toronto (CA)

(73) Assignee: LG ELECTRONICS INC., Seoul (KR)

(21) Appl. No.: 18/406,747

(22) Filed: Jan. 8, 2024

Related U.S. Application Data
(60) Provisional application No. 63/437,368, filed on Jan. 6, 2023.

(51) Int. Cl. G06N 3/08; G06N 3/042

(52) U.S. Cl. CPC G06N 3/08; G06N 3/042

(57) ABSTRACT

A method for controlling an artificial intelligence (AI) device can include obtaining, via a processor in the AI device, a knowledge graph, training, via the processor, a link prediction model on the knowledge graph to generate a trained link prediction model, extracting, via the processor, logic rules from the trained link prediction model, generating, via the processor, at least one evaluation metric based on the logic rules, and generating, via the processor, evaluation results based on comparing the at least one evaluation metric to a predetermined criteria, and outputting, via an output unit in the AI device, the evaluation results. Also, the method can include saving the trained link prediction model in a memory of the AI device for deployment or transmitting the trained link prediction model to an external device for deployment, based on the evaluation results.

### CROSS-REFERENCE TO RELATED APPLICATIONS

This non-provisional application claims priority under 35 U.S.C. § 119(e) to U.S. Provisional Application No. 63/437,368, filed on Jan. 6, 2023, the entirety of which is hereby expressly incorporated by reference into the present application.

### BACKGROUND

### Field

The present disclosure relates to an evaluation device and method, in the field of artificial intelligence (AI). Particularly, the method can provide objective metrics and subjective metrics for evaluating and selecting a link prediction algorithm, in the AI field.

### Discussion of the Related Art

Artificial intelligence (AI) continues to transform various aspects of society and helps users more efficiently retrieve information whether in the form of question and answering systems or recommendations systems.

While AI has revolutionized various fields, its lack of transparency often hinders user trust and adoption. Explainable AI (XAI) techniques attempt to bridge this gap by providing insights into how AI systems arrive at their results.

For example, AI systems often operate as black boxes, making it difficult to understand the reasoning behind their answers. This lack of transparency can raise concerns about bias, fairness, and overall reliability. Additionally, users often desire insights into how their queries are processed and interpreted, allowing them to evaluate the validity and relevance of the provided answers. There exists a need to illuminate the inner workings of these systems, giving users a window into the logical and factual pathways that lead to each answer.

Learning logic rules for an AI system can be leveraged for interpretability and can shed light on the decision making process. Link prediction metrics are often used as a proxy for determining and assessing the quality of the logic rules. However, high link prediction metrics do not necessarily translate to high quality graph coverage through logic rules and do not have high predictive power with respect to the quality of the logic rules. Thus, there exists a need for comprehensive evaluation of logic rules in knowledge graphs (KGs) and their corresponding link prediction algorithms.

In addition, there exists a need for the ability to effectively evaluate the logic rules produced based on a link prediction algorithm or model, which could improve human-AI interactions, help select or determine the best link prediction algorithm, and accelerate the adoption of AI technologies across diverse fields.

### SUMMARY OF THE DISCLOSURE

The present disclosure has been made in view of the above problems and it is an object of the present disclosure to provide a device and method that can provide an evaluation device and method, in the field of artificial intelligence (AI). Further, the method can provide objective metrics and subjective metrics for evaluating and selecting a link prediction algorithm.

It is another object of the present disclosure to provide a method for controlling an artificial intelligence (AI) device that includes obtaining, via a processor in the AI device, a knowledge graph, training, via the processor, a link prediction model on the knowledge graph to generate a trained link prediction model, extracting, via the processor, logic rules from the trained link prediction model, generating, via the processor, at least one evaluation metric based on the logic rules, generating, via the processor, an evaluation result based on comparing the at least one evaluation metric to a predetermined criteria, and outputting, via an output unit in the AI device, the evaluation result.

An object of the present disclosure is to provide a method for controlling an artificial intelligence (AI) device that includes saving the trained link prediction model in a memory of the AI device for deployment or transmitting the trained link prediction model to an external device for deployment, based on the evaluation results.

Another object of the present disclosure is to provide a method for controlling an artificial intelligence (AI) device, which the trained link prediction model is deployed in a question and answer system or a recommendation system.

An object of the present disclosure is to provide a method for controlling an artificial intelligence (AI) device that includes generating a rules recovered metric, the rules recovered metric being a value based on dividing a number of the logic rules by a total number of original logic rules for the knowledge graph, and generating a graph coverage metric, the graph coverage metric being a value based on dividing a number of grounded paths covered by the logic rules by a total number of ground paths for the knowledge graph.

Another object of the present disclosure is to provide a method for controlling an artificial intelligence (AI) device that includes comparing the rules recovered metric to a first predetermined threshold, comparing the graph coverage metric to a second predetermined threshold, and in response to the rules recovered metric being greater than or equal to the first predetermined threshold and the graph coverage metric being greater than or equal to the second predetermined threshold, saving the trained link prediction model in a memory of the AI device for deployment or transmitting the trained link prediction model to an external device for deployment.

An object of the present disclosure is to provide a method for controlling an artificial intelligence (AI) device that includes receiving a plurality of scores for each logic rule among the logic rules, the plurality of scores being assigned by a plurality of annotators, and generating one quality score for the logic rules based on a sum of the plurality of scores and based on dividing by a total number of the logic rules.

Another object of the present disclosure is to provide a method for controlling an artificial intelligence (AI) device, in which each of the plurality of scores is a binary value of a 1 or a 0.

An object of the present disclosure is to provide a method for controlling an artificial intelligence (AI) device that includes comparing the one quality score to a third predetermined threshold, and in response to the one quality score being greater than or equal to the third predetermined threshold, saving the trained link prediction model in a memory of the AI device for deployment or transmitting the trained link prediction model to an external device for deployment.

An object of the present disclosure is to provide a method for controlling an artificial intelligence (AI) device that includes generating link prediction metrics based on the trained link prediction model, the link prediction metrics including at least one of mean rank (MR), mean reciprocal rank (MRR), and Hit@K, and determining whether to deploy the trained link prediction model based on the link prediction metrics.

An object of the present disclosure is to provide a method for controlling an artificial intelligence (AI) device, in which the AI device includes at least one of a smart television, a mobile phone, and a home appliance device.

An object of the present disclosure is to provide an artificial intelligence (AI) device for providing recommendations that includes a memory configured to store knowledge graph information, and a controller configured to obtain a knowledge graph, train a link prediction model on the knowledge graph to generate a trained link prediction model, extract logic rules from the trained link prediction model, generate at least one evaluation metric based on the logic rules, generate an evaluation result based on comparing the at least one evaluation metric to a predetermined criteria, and output the evaluation result.

Another object of the present disclosure is to provide a method for controlling an artificial intelligence (AI) device that includes obtaining, via a processor in the AI device, a knowledge graph, training, via the processor, a link prediction model on the knowledge graph to generate a trained link prediction model, extracting, via the processor, logic rules from the trained link prediction model, generating, via the processor, a rules recovered metric by dividing a number of the logic rules by a total number of original logic rules for the knowledge graph, generating, via the processor, a graph coverage metric by dividing a number of grounded paths covered by the logic rules by a total number of ground paths for the knowledge graph, and outputting the rules recovered metric and the graph coverage metric.

In addition to the objects of the present disclosure as mentioned above, additional objects and features of the present disclosure will be clearly understood by those skilled in the art from the following description of the present disclosure.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 illustrates an AI device according to an embodiment of the present disclosure.

FIG. 2 illustrates an AI server according to an embodiment of the present disclosure.

FIG. 3 illustrates an AI device according to an embodiment of the present disclosure.

FIG. 4 shows an example flow chart for a method in the AI device, according to an embodiment of the present invention.

FIGS. 5A, 5B and 5C illustrate performance regrading extracted logic rules and graph coverage according to an embodiment of the present disclosure.

### DETAILED DESCRIPTION OF THE EMBODIMENTS

Reference will now be made in detail to the embodiments of the present disclosure, examples of which are illustrated in the accompanying drawings.

Wherever possible, the same reference numbers will be used throughout the drawings to refer to the same or like parts.

Advantages and features of the present disclosure, and implementation methods thereof will be clarified through following embodiments described with reference to the accompanying drawings.

The present disclosure can, however, be embodied in different forms and should not be construed as limited to the embodiments set forth herein.

Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details.

Like reference numerals refer to like elements throughout. In the following description, when the detailed description of the relevant known function or configuration is determined to unnecessarily obscure the important point of the present disclosure, the detailed description will be omitted.

In a situation where “comprise,” “have,” and “include” described in the present specification are used, another part can be added unless “only” is used. The terms of a singular form can include plural forms unless referred to the contrary.

In construing an element, the element is construed as including an error range although there is no explicit description. In describing a position relationship, for example, when a position relation between two parts is described as “on,” “over,” “under,” and “next,” one or more other parts can be disposed between the two parts unless ‘just’ or ‘direct’ is used.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc. can be used herein to describe various elements, these elements should not be limited by these terms.

These terms are only used to distinguish one element from another. For example, a first element could be termed a second element, and, similarly, a second element could be termed a first element, without departing from the scope of the present disclosure.

Further, “X-axis direction,” “Y-axis direction” and “Z-axis direction” should not be construed by a geometric relation only of a mutual vertical relation and can have broader directionality within the range that elements of the present disclosure can act functionally.

The term “at least one” should be understood as including any and all combinations of one or more of the associated listed items.

For example, the meaning of “at least one of a first item, a second item and a third item” denotes the combination of all items proposed from two or more of the first item, the second item and the third item as well as the first item, the second item or the third item.

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship.

Hereinafter, the preferred embodiments of the present disclosure will be described in detail with reference to the accompanying drawings. All the components of each device or apparatus according to all embodiments of the present disclosure are operatively coupled and configured.

Artificial intelligence (AI) refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and can mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network can include an input layer, an output layer, and optionally one or more hidden layers. Each layer includes one or more neurons, and the artificial neural network can include a synapse that links neurons to neurons. In the artificial neural network, each neuron can output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network can be to determine the model parameters that minimize a loss function. The loss function can be used as an index to determine optimal model parameters in the learning process of the artificial neural network.

Machine learning can be classified into supervised learning, unsupervised learning, and reinforcement learning according to a learning method.

The supervised learning can refer to a method of learning an artificial neural network in a state in which a label for learning data is given, and the label can mean the correct answer (or result value) that the artificial neural network must infer when the learning data is input to the artificial neural network. The unsupervised learning can refer to a method of learning an artificial neural network in a state in which a label for learning data is not given. The reinforcement learning can refer to a learning method in which an agent defined in a certain environment learns to select a behavior or a behavior sequence that maximizes cumulative compensation in each state.

Machine learning, which can be implemented as a deep neural network (DNN) including a plurality of hidden layers among artificial neural networks, is also referred to as deep learning, and the deep learning is part of machine learning. In the following, machine learning is used to mean deep learning.

Self-driving refers to a technique of driving for oneself, and a self-driving vehicle refers to a vehicle that travels without an operation of a user or with a minimum operation of a user.

For example, the self-driving can include a technology for maintaining a lane while driving, a technology for automatically adjusting a speed, such as adaptive cruise control, a technique for automatically traveling along a predetermined route, and a technology for automatically setting and traveling a route when a destination is set.

The vehicle can include a vehicle having only an internal combustion engine, a hybrid vehicle having an internal combustion engine and an electric motor together, and an electric vehicle having only an electric motor, and can include not only an automobile but also a train, a motorcycle, and the like.

At this time, the self-driving vehicle can be regarded as a robot having a self-driving function.

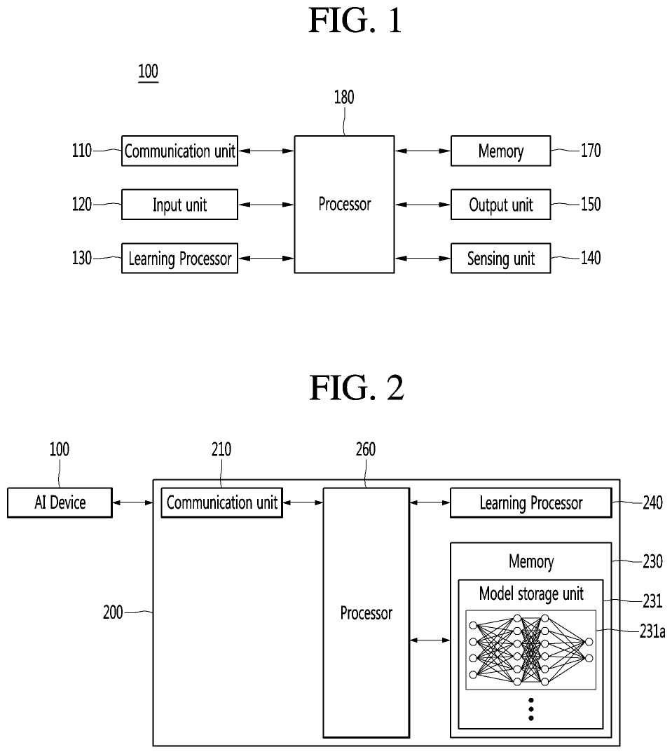

FIG. 1 illustrates an artificial intelligence (AI) device 100 according to one embodiment.

The AI device 100 can be implemented by a stationary device or a mobile device, such as a television (TV), a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like. However, other variations are possible.

Referring to FIG. 1, the AI device 100 can include a communication unit 110 (e.g., transceiver), an input unit 120 (e.g., touchscreen, keyboard, mouse, microphone, etc.), a learning processor 130, a sensing unit 140 (e.g., one or more sensors or one or more cameras), an output unit 150 (e.g., a display or speaker), a memory 170, and a processor 180 (e.g., a controller).

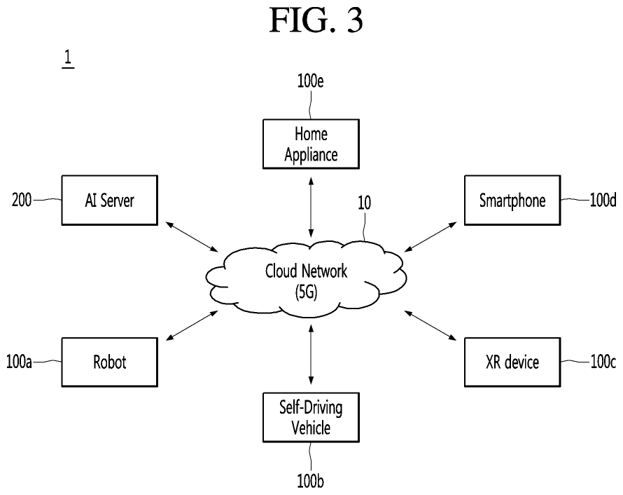

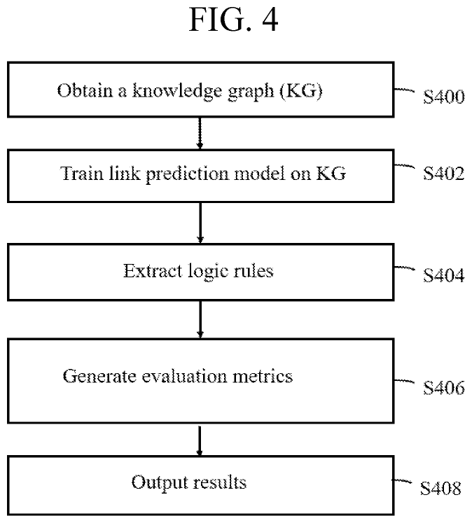

The communication unit 110 (e.g., communication interface or transceiver) can transmit and receive data to and from external devices such as other AI devices 100a to 100e and the AI server 200 (e.g., FIGS. 2 and 3) by using wire/wireless communication technology. For example, the communication unit 110 can transmit and receive sensor information, a user input, a learning model, and a control signal to and from external devices.

The communication technology used by the communication unit 110 can include GSM (Global System for Mobile communication), CDMA (Code Division Multi Access), LTE (Long Term Evolution), 5G, WLAN (Wireless LAN), Wi-Fi (Wireless-Fidelity), BLUETOOTH, RFID (Radio Frequency Identification), Infrared Data Association (IrDA), ZIGBEE, NFC (Near Field Communication), and the like.

The input unit 120 can acquire various kinds of data.

At this time, the input unit 120 can include a camera for inputting a video signal, a microphone for receiving an audio signal, and a user input unit for receiving information from a user. The camera or the microphone can be treated as a sensor, and the signal acquired from the camera or the microphone can be referred to as sensing data or sensor information.

The input unit 120 can acquire a learning data for model learning and an input data to be used when an output is acquired by using a learning model. The input unit 120 can acquire raw input data. In this situation, the processor 180 or the learning processor 130 can extract an input feature by preprocessing the input data.

The learning processor 130 can learn a model composed of an artificial neural network by using learning data. The learned artificial neural network can be referred to as a learning model. The learning model can be used to infer a result value for new input data rather than learning data, and the inferred value can be used as a basis for determination to perform a certain operation.

At this time, the learning processor 130 can perform AI processing together with the learning processor 240 of the AI server 200.

At this time, the learning processor 130 can include a memory integrated or implemented in the AI device 100. Alternatively, the learning processor 130 can be implemented by using the memory 170, an external memory directly connected to the AI device 100, or a memory held in an external device.

The sensing unit 140 can acquire at least one of internal information about the AI device 100, ambient environment information about the AI device 100, and user information by using various sensors.

Examples of the sensors included in the sensing unit 140 can include a proximity sensor, an illuminance sensor, an acceleration sensor, a magnetic sensor, a gyro sensor, an inertial sensor, an RGB sensor, an IR (infrared) sensor, a fingerprint recognition sensor, an ultrasonic sensor, an optical sensor, a camera, a microphone, a lidar, and a radar.

The output unit 150 can generate an output related to a visual sense, an auditory sense, or a haptic sense.

At this time, the output unit 150 can include a display unit for outputting time information, a speaker for outputting auditory information, and a haptic module for outputting haptic information.

The memory 170 can store data that supports various functions of the AI device 100. For example, the memory 170 can store input data acquired by the input unit 120, learning data, a learning model, a learning history, and the like.

The processor 180 can determine at least one executable operation of the AI device 100 based on information determined or generated by using a data analysis algorithm or a machine learning algorithm. The processor 180 can control the components of the AI device 100 to execute the determined operation. For example, the processor 180 can evaluate logic rules for a question and answering system or a recommendation system. Also, processor 180 can select a best link predication algorithm among a plurality of link predication algorithms based on evaluation metrics.

To this end, the processor 180 can request, search, receive, or utilize data of the learning processor 130 or the memory 170. The processor 180 can control the components of the AI device 100 to execute the predicted operation or the operation determined to be desirable among the at least one executable operation.

When the connection of an external device is required to perform the determined operation, the processor 180 can generate a control signal for controlling the external device and can transmit the generated control signal to the external device.

The processor 180 can acquire information for the user input and can determine an answer or a recommended item or action based on the acquired intention information.

The processor 180 can acquire the information corresponding to the user input by using at least one of a speech to text (STT) engine for converting speech input into a text string or a natural language processing (NLP) engine for acquiring intention information of a natural language.

At least one of the STT engine or the NLP engine can be configured as an artificial neural network, at least part of which is learned according to the machine learning algorithm. At least one of the STT engine or the NLP engine can be learned by the learning processor 130, can be learned by the learning processor 240 of the AI server 200 (see FIG. 2), or can be learned by their distributed processing.

The processor 180 can collect history information including user profile information, the operation contents of the AI device 100 or the user's feedback on the operation and can store the collected history information in the memory 170 or the learning processor 130 or transmit the collected history information to the external device such as the AI server 200. The collected history information can be used to update the learning model.

The processor 180 can control at least part of the components of AI device 100 to drive an application program stored in memory 170. Furthermore, the processor 180 can operate two or more of the components included in the AI device 100 in combination to drive the application program.

FIG. 2 illustrates an AI server according to one embodiment.

Referring to FIG. 2, the AI server 200 can refer to a device that learns an artificial neural network by using a machine learning algorithm or uses a learned artificial neural network. The AI server 200 can include a plurality of servers to perform distributed processing, or can be defined as a 5G network, 6G network or other communications network. At this time, the AI server 200 can be included as a partial configuration of the AI device 100, and can perform at least part of the AI processing together.

The AI server 200 can include a communication unit 210, a memory 230, a learning processor 240, a processor 260, and the like.

The communication unit 210 can transmit and receive data to and from an external device such as the AI device 100.

The memory 230 can include a model storage unit 231. The model storage unit 231 can store a learning or learned model (or an artificial neural network 231a) through the learning processor 240.

The learning processor 240 can learn the artificial neural network 231a by using the learning data. The learning model can be used in a state of being mounted on the AI server 200 of the artificial neural network, or can be used in a state of being mounted on an external device such as the AI device 100.

The learning model can be implemented in hardware, software, or a combination of hardware and software. If all or part of the learning models are implemented in software, one or more instructions that constitute the learning model can be stored in the memory 230.

The processor 260 can infer the result value for new input data by using the learning model and can generate a response or a control command based on the inferred result value.

FIG. 3 illustrates an AI system 1 including a terminal device according to one embodiment.

Referring to FIG. 3, in the AI system 1, at least one of an AI server 200, a robot 100a, a self-driving vehicle 100b, an XR (extended reality) device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, can be referred to as AI devices 100a to 100e. The AI server 200 of FIG. 3 can have the configuration of the AI server 200 of FIG. 2.

According to an embodiment, the evaluation method can be implemented as an application or program that can be downloaded or installed in the smartphone 100d, which can communicate with the AI server 200, but embodiments are not limited thereto.

The cloud network 10 can refer to a network that forms part of a cloud computing infrastructure or exists in a cloud computing infrastructure. The cloud network 10 can be configured by using a 3G network, a 4G or LTE network, a 5G network, a 6G network, or other network.

For instance, the devices 100a to 100e and 200 configuring the AI system 1 can be connected to each other through the cloud network 10. In particular, each of the devices 100a to 100e and 200 can communicate with each other through a base station, but can directly communicate with each other without using a base station.

The AI server 200 can include a server that performs AI processing and a server that performs operations on big data.

The AI server 200 can be connected to at least one of the AI devices constituting the AI system 1, that is, the robot 100a, the self-driving vehicle 100b, the XR device 100c, the smartphone 100d, or the home appliance 100e through the cloud network 10, and can assist at least part of AI processing of the connected AI devices 100a to 100e.

At this time, the AI server 200 can learn the artificial neural network according to the machine learning algorithm instead of the AI devices 100a to 100e, and can directly store the learning model or transmit the learning model to the AI devices 100a to 100e.

At this time, the AI server 200 can receive input data from the AI devices 100a to 100e, can infer the result value for the received input data by using the learning model, can generate a response or a control command based on the inferred result value, and can transmit the response or the control command to the AI devices 100a to 100e. Each AI device 100a to 100e can have the configuration of the AI device 100 of FIGS. 1 and 2 or other suitable configurations.

Alternatively, the AI devices 100a to 100e can infer the result value for the input data by directly using the learning model, and can generate the response or the control command based on the inference result.

Hereinafter, various embodiments of the AI devices 100a to 100e to which the above-described technology is applied will be described. The AI devices 100a to 100e illustrated in FIG. 3 can be regarded as a specific embodiment of the AI device 100 illustrated in FIG. 1.

According to an embodiment, the home appliance 100e can be a smart television (TV), smart microwave, smart oven, smart refrigerator or other display device, which can implement one or more of an evaluation method, a question and answering system or a recommendation system. The method can be the form of an executable application or program.

The robot 100a, to which the AI technology is applied, can be implemented as an entertainment robot, a guide robot, a carrying robot, a cleaning robot, a wearable robot, a pet robot, an unmanned flying robot, or the like.

The robot 100a can include a robot control module for controlling the operation, and the robot control module can refer to a software module or a chip implementing the software module by hardware.

The robot 100a can acquire state information about the robot 100a by using sensor information acquired from various kinds of sensors, can detect (recognize) surrounding environment and objects, can generate map data, can determine the route and the travel plan, can determine the response to user interaction, or can determine the operation.

The robot 100a can use the sensor information acquired from at least one sensor among the lidar, the radar, and the camera to determine the travel route and the travel plan.

The robot 100a can perform the above-described operations by using the learning model composed of at least one artificial neural network. For example, the robot 100a can recognize the surrounding environment and the objects by using the learning model, and can determine the operation by using the recognized surrounding information or object information. The learning model can be learned directly from the robot 100a or can be learned from an external device such as the AI server 200.

At this time, the robot 100a can perform the operation by generating the result by directly using the learning model, but the sensor information can be transmitted to the external device such as the AI server 200 and the generated result can be received to perform the operation.

The robot 100a can use at least one of the map data, the object information detected from the sensor information, or the object information acquired from the external apparatus to determine the travel route and the travel plan, and can control the driving unit such that the robot 100a travels along the determined travel route and travel plan. Further, the robot 100a can determine an action to pursue or an item to recommend. Also, the robot 100a can generate an answer in response to a user query. The answer can be in the form of natural language.

The map data can include object identification information about various objects arranged in the space in which the robot 100a moves. For example, the map data can include object identification information about fixed objects such as walls and doors and movable objects such as pollen and desks. The object identification information can include a name, a type, a distance, and a position.

In addition, the robot 100a can perform the operation or travel by controlling the driving unit based on the control/interaction of the user. At this time, the robot 100a can acquire the intention information of the interaction due to the user's operation or speech utterance, and can determine the response based on the acquired intention information, and can perform the operation.

The robot 100a, to which the AI technology and the self-driving technology are applied, can be implemented as a guide robot, a carrying robot, a cleaning robot (e.g., an automated vacuum cleaner), a wearable robot, an entertainment robot, a pet robot, an unmanned flying robot (e.g., a drone or quadcopter), or the like.

The robot 100a, to which the AI technology and the self-driving technology are applied, can refer to the robot itself having the self-driving function or the robot 100a interacting with the self-driving vehicle 100b.

The robot 100a having the self-driving function can collectively refer to a device that moves for itself along the given movement line without the user's control or moves for itself by determining the movement line by itself.

The robot 100a and the self-driving vehicle 100b having the self-driving function can use a common sensing method to determine at least one of the travel route or the travel plan. For example, the robot 100a and the self-driving vehicle 100b having the self-driving function can determine at least one of the travel route or the travel plan by using the information sensed through the lidar, the radar, and the camera.

The robot 100a that interacts with the self-driving vehicle 100b exists separately from the self-driving vehicle 100b and can perform operations interworking with the self-driving function of the self-driving vehicle 100b or interworking with the user who rides on the self-driving vehicle 100b.

In addition, the robot 100a interacting with the self-driving vehicle 100b can control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b can monitor the user boarding the self-driving vehicle 100b, or can control the function of the self-driving vehicle 100b through the interaction with the user. For example, when it is determined that the driver is in a drowsy state, the robot 100a can activate the self-driving function of the self-driving vehicle 100b or assist the control of the driving unit of the self-driving vehicle 100b. The function of the self-driving vehicle 100b controlled by the robot 100a can include not only the self-driving function but also the function provided by the navigation system or the audio system provided in the self-driving vehicle 100b.

Alternatively, the robot 100a that interacts with the self-driving vehicle 100b can provide information or assist the function to the self-driving vehicle 100b outside the self-driving vehicle 100b. For example, the robot 100a can provide traffic information including signal information and the like, such as a smart signal, to the self-driving vehicle 100b, and automatically connect an electric charger to a charging port by interacting with the self-driving vehicle 100b like an automatic electric charger of an electric vehicle.

According to an embodiment, the AI device 100 can generate evaluation metrics based on a link prediction algorithm and knowledge graph.

According to another embodiment, the AI device 100 can be integrated into an infotainment system of the self-driving vehicle 100b, which can recommend content or provide answers based on various input modalities, the content can include one or more of audio recordings, video, music, pod casts, etc., but embodiments are not limited thereto. Also, the AI device 100 can be integrated into an infotainment system of the manual or human-driving vehicle.

Link prediction is a prevalent challenge in graph analysis, and it is often possible to interpret the results of link prediction tasks through logic rules, which can enhance interpretability and improve applications such as information retrieval and question answering. However, high link prediction scores do not necessarily lead to comprehensive coverage of the knowledge graph through logic rules. Additionally, link prediction metrics do not reliably predict the quality of logic rules.

According to an embodiment, a method can include conducting a systematic evaluation of the quality of logic rules on datasets, in which objective and subjective evaluation regarding link prediction metrics can be provided to assess the quality of logic rules. Further, the objective evaluation metrics can be based on a rules recovered (RR) measurement and a graph coverage (GC) measurement, described in more detail below.

In addition, according to an embodiment, a method can further include subjective evaluation metrics based on feedback from users, which can be referred to as a quality score.

For instance, the method can include providing both objective evaluation metrics and subjective evaluation metrics for logic rules for assessing the logic rules and the corresponding link prediction algorithm. Also, the method can provide a robust evaluation method that can accurately predict the quality of the resulting logic rules, and for the development of new approaches for learning these rules that can better handle real-world, common sense reasoning tasks.

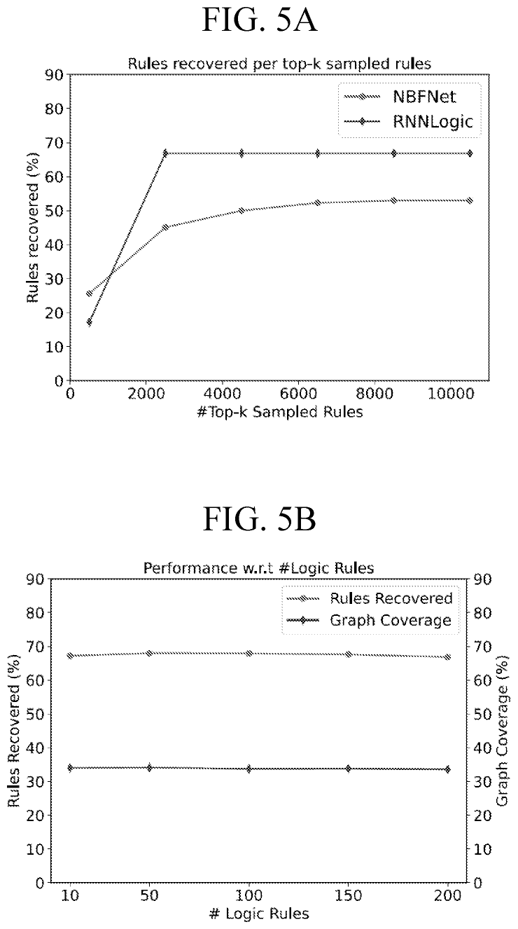

FIG. 4 shows an example flow chart of a method according to an embodiment. For example, the AI device 100 can be configured with a method for controlling an artificial intelligence (AI) device that includes obtaining a knowledge graph (e.g., S400), training or learning a link prediction algorithm or model on the knowledge graph (e.g., S402), extracting logic rules based on the knowledge graph and the trained link prediction algorithm (e.g., S404), generating metrics for evaluating the logic rules and the trained link prediction algorithm (e.g., S406), and outputting results (e.g., S408).

According to another embodiment, an method of controlling an AI device 100 can include a method for controlling an artificial intelligence (AI) device that includes obtaining, via a processor in the AI device, a knowledge graph, training, via the processor, a link prediction model on the knowledge graph to generate a trained link prediction model, extracting, via the processor, logic rules from the trained link prediction model, generating, via the processor, at least one evaluation metric based on the logic rules, generating, via the processor, an evaluation result based on comparing the at least one evaluation metric to a predetermined criteria, and outputting, via an output unit in the AI device, the evaluation result. Also, the evaluation results can be in the form of a pass or fail indication, or a score (e.g., a percentage out of 100), but embodiments are not limited thereto.

Also, the method can include comparing the evaluation metrics to predetermined thresholds or to evaluation metrics of other link prediction algorithms, in order to determine whether to deploy the trained link prediction algorithm and/or select the link prediction algorithm over the other link prediction algorithms. Further, the trained link prediction algorithm can be deployed in a recommendation system or a question and answering system.

The AI device 100 can obtain a knowledge graph, which can include a web of interconnected facts and entities (e.g., a web of knowledge). A knowledge graph is a structured way to store and represent information, capturing relationships between entities and concepts in a way that machines can understand and reason with.

According to an embodiment, the AI device 100 can include one or more knowledge graphs that include entities and properties or information about people or items (e.g., names, user IDs), products (e.g., display devices, home appliances, etc.), profile information (e.g., age, gender, weight, location, etc.), recipe categories, ingredients, images, purchases and reviews.

According to an embodiment, a knowledge graph can capture real world knowledge in the form of a graph structure modeled as (h, r, t) triplets where h and t refer to a head entity and a tail entity respectively, and r is a relationship that connects the two entities.

Also, knowledge graph completion can refer to a process of filling in missing information in a knowledge graph, making it more comprehensive and accurate (e.g., similar to piecing together a puzzle, uncovering hidden connections and expanding the knowledge base). Link prediction can identify missing links in a knowledge graph (KG) and assist with downstream tasks such as question answering and recommendation systems.

In addition, AI based question answering and recommendation systems often rely on complex neural architectures, and it is desirable to be able to interpret and explain predications made by the AI system. One such approach is the use of logic rules, e.g., a rule in the conjunctive form ∀{Xᵢ}^{l}=0 r(X₀, Xₗ)←r₁(X₀, X₁)∧ . . . ∧rₗ (X₁₋₁, X₁), where l is the length of the rule and the inferred relation, and r defines the relationship between the starting and ending entities (X₀, X₁).

For example, various techniques can be applied to extract logic rules from a link prediction algorithm's output. This can help uncover the underlying reasoning patterns that lead to the predicted links. For instance, if a link prediction algorithm trained on a knowledge graph outputs that “A” is the father of “B,” and “B” is the father of “C,” then a logic rule can be extracted that states “A” is the grandfather of “C.” Also, the extracted logic rules can be used to reconstruct the knowledge graph. For example, based on the logic rule that “A” is the grandfather of “C,” then it can be reconstructed that “A” is the father of “B” and “B” is the father of “C,” and the corresponding nodes and links can be reconstructed for a portion of the knowledge graph.

In addition, an example logic rule can be in the form of capturing the type of relations including symmetric relations, e.g., (plant, near, lamp)←(lamp, near, plant), as well as inverse relations, e.g., (giraffe, has, ear)←(ear, part of, giraffe). Also, the logic rules can include compositional relations, e.g., (clock, of, building)←(building, attached to, building) A (building, under, clock), but embodiments are not limited thereto.

Also, the logic rules can capture if-then knowledge relations, e.g., (PersonX_holds_out_PersonXs_hand_to_PersonY, xIntent, helpful)←(PersonX_takes_home, xReact, helpful) ∧(PersonX_takes_home, xReact, kind) ∧(PersonX_holds_out_PersonXs_hand_to_PersonY, xIntent, kind). This example shows how the two terms, “PersonX_holds_out_PersonXs_hand_to_PersonY” and “helpful” can be linked together based on other relations.

A link prediction algorithm trained on a knowledge graph can be evaluated based on various link prediction metrics (e.g., mean rank (MR), mean reciprocal rank (MRR), and Hit@K). Link prediction metrics are often used as a proxy for determining and assessing the quality of the logic rules.

However, good link prediction metrics do not necessarily translate to high quality graph coverage through logic rules and do not have high predictive power with respect to the quality of the logic rules. For instance, an incorrect assumption of a positive correlation between high link prediction metrics and the quality of the logic rules can lead to practices of saving model checkpoints based on high link prediction scores during training, even when these checkpoints do not yield high quality logic rules.

According to an embodiment, the AI device 100 is configured to implement a method that includes generating objective metrics to assess the quality of the logic rules. The objective metrics can be referred to as rules recovered (RR) and graph coverage (GC). According to another embodiment, the method can also include generating subjective metrics based on feedback from users to generate a quality score.

For instance, rules recovered (RR) can be defined as the ratio of logic rules retrieved by the algorithm to the total number of original logic rules used to generate the input dataset (e.g., one or more knowledge graphs). The rules recovered (RR) metric is expressed as equation 1 below.

$$Rules Recovered = \frac{number of rules retrieved}{total number of original rules} \qquad [ Equation 1 ]$$

Also, the rules recovered (RR) metric can be in the form of a percentage.

In addition, graph coverage (GC) be defined as the ratio of grounding paths on a knowledge graph that can be covered by the recovered rules. The graph coverage (GC) metric is expressed as equation 2 below.

$$Graph Coverage = \frac{\begin{matrix}number of grounded paths \\ covered by recovered rules\end{matrix}}{total number of grounded paths} \qquad [ Equation 2 ]$$

Also, the graph coverage (GC) metric can be in the form of a percentage.

According to an embodiment, the rules recovered (RR) metric and the graph coverage (GC) metric can be determined for a specific link prediction algorithm that is trained on a knowledge graph and can be compared to a first predetermined threshold and a second predetermined threshold respectively, in order to determine whether or not to deploy the link prediction algorithm. Also, the method can include transmitting the specific link prediction algorithm to one or more external devices for deployment.

For example, the first predetermined threshold can be set to 66% and the second predetermined threshold can be set to 33%, but embodiments are not limited thereto. For example, the values of the first and second thresholds can be adjusted according to design considerations, etc.

According to an embodiment, the method can include deploying or transmitting the link prediction algorithm when the rules recovered (RR) metric is greater than or equal to the first predetermined threshold and the graph coverage (GC) metric is greater than or equal to the second predetermined threshold (e.g., if both thresholds are satisfied), but embodiments are not limited thereto. For example, according to another embodiment, the method can include deploying or transmitting the link prediction algorithm when at least one of the first predetermined threshold and second predetermined threshold is satisfied.

According to an embodiment, upon satisfying one or more predetermined conditions, the link prediction algorithm can be deployed in a question and answering system or a recommendation system, etc.

In addition, the method of the AI device 100 can include generating subjective metrics for a link prediction algorithm that is trained on a knowledge graph. For example, some knowledge graphs may not have reliable corresponding ground truth logic rules, in this situation subjective metrics can be used in place of or in addition to the objective metrics described above, but embodiments are not limited thereto.

According to an embodiment, the method of the AI device 100 can include considering the latest M checkpoints (thus, M sources of link prediction metrics) of each dataset (knowledge graph), and the top-K logic rules based on the model's produced scores can be extracted for evaluation. A metric referred to as quality score (QS) can be used to capture the overall quality of the logic rules generated by a checkpoint. The quality score (QS) metric is expressed as equation 3 below.

$$Quality Score = \frac{1}{n} {\sum }_{i = 1}^{n} 1 ( {rule}_{i} ) , \qquad [ Equation 3 ]$$

In the quality score (QS) equation above, n is the number of rules, ¹(·) is an Indicator function that evaluates to 1 if ruleᵢ is a qualitative rule, and 0 otherwise. For example, annotators can rate the quality of the rules on a binary scale, e.g., 0: not useful, 1: useful. According to an embodiment the annotators can be users (e.g., humans), but embodiments are not limited thereto.

According to an embodiment, the method can include deploying or transmitting the link prediction algorithm when the quality score (QS) metric is greater than or equal to a third predetermined threshold, but embodiments are not limited thereto. Also, upon a successful determination, the link prediction algorithm can be saved in the AI device 100 for deployment or transmitted to one or more external devices for deployment. For example, the link prediction algorithm can be deployed in a question and answering system or a recommendation system, etc.

In addition, the method of the AI device 100 can include determining to deploy or transmit the link prediction algorithm based on one or more of the rules recovered (RR) metric, the graph coverage (GC) metric and the quality score (QS) metric, but embodiments are not limited thereto.

According to another embodiment, the method of the AI device 100 can include determining to deploy or transmit the link prediction algorithm based on one or more link prediction metrics (e.g., mean rank (MR), mean reciprocal rank (MRR), and Hit@K) and based on one or more of the rules recovered (RR) metric, the graph coverage (GC) metric and the quality score (QS) metric, but embodiments are not limited thereto.

An example of the evaluation method applied to an RNNLogic model and a NBFNet model is described below.

RNNLogic is an Expectation Maximization (EM)-based model including two components, e.g., a rule generator and a reasoning predictor, which are simultaneously trained to enhance each other. The rule generator provides logic rules that are used by the reasoning predictor, and the reasoning predictor provides an effective reward for training the rule generator, thereby reducing search spaces significantly.

For example, for each query q=(h, r, ?) and answer a=1, a model for the probability of an answer is conditioned on the query and the underlying knowledge graph G, as p(a|G, q), where logic rules z are treated as latent variables. The rule generator is parameterized by a recurrent neural network that defines a prior distribution over logic rules for each query, e.g., p(z|q). In the reasoning predictor, the likelihood of an answer is computed conditioned on logic rules and the knowledge graph G, e.g., p(a|G, q, z). At each iteration, the rule generator produces a set of logic rules, and then the reasoning predictor is updated to explore these rules for reasoning.

NBFNet is a scalable path-based graph neural network framework for link prediction that solves the path formulation with learned operators in the Generalized Bellman-Ford Algorithm (GBFA). The original Bellman-Ford algorithm solves the single source shortest path problem even in the existence of negative edges. The formulation of the shortest path problem is defined by the equation below.

$$dsp = min p ∈ Pw ( p ) = min p ∈ P {\sum }_{i} wi$$

In the equation above, P is a set of paths on the graph and w is the weight of the path which is the sum of the weights of its constituting edges. The GBFA generalizes the equation by the use of semiring structure, (S,⊕,⊗), where S is the carrier set and ⊕ and ⊗ are two binary operators on S. In addition, ⊕ is commutative and associative operator with the neutral element [symbol] with three neural networks.

NBFNet includes many path-based techniques that can be used in both transductive and inductive settings on homogeneous and heterogeneous graphs. As a result, it can produce interpretable predictions through paths in the form of logic rules by approximating the local landscape of the model with the linear model over the set of all paths, e.g., 1st-order Taylor polynomial.

Since directly computing the importance of all paths can be intractable, the edge importance of each path is approximated by the sum of the importance of edges in that path. RNNLogic, on the other hand, is a principled probabilistic approach that learns the logic rules for knowledge graph reasoning. It addresses the problem of searching through a large logic rule space and explicitly generates high-quality logic rules using its rules generator.

Further in this example, Graphlog can be used. GraphLog includes 57 distinct datasets designed to evaluate logical generalization in graph neural networks. Primarily designed as a benchmarking framework for relation prediction tasks, the individual datasets are generated from first-order logic rules. The rules overlap across datasets by design, e.g., this is meant to capture distribution shifts across the datasets. Additionally, dataset generation is configurable to enable evaluating the role of diversity of generalization. For each dataset, 80% of triplets are randomly sampled for training, 10% of triplets are used for validation and 10% for testing. The graphs are categorized into three categories of difficulty, e.g., easy, moderate, and difficult, based on the relative test performance of the models.

In addition, RNNLogic and the NBFNet can be evaluated based on link prediction metrics (e.g., mean rank (MR), mean reciprocal rank (MRR), and Hit@K) and based the rules recovered (RR) metric, the graph coverage (GC) metric.

Table 1 below illustrates knowledge graph completion and logic rules inference metrics performance on GraphLog datasets marked by dataset difficulty.

TABLE 1

| Algorithm | Difficulty | MR↓ | MRR↑ | H@1↑ | H@3↑ | H@10↑ | RR ↑ | GC ↑ |
|---|---|---|---|---|---|---|---|---|
| RNNLogic | Easy | 113 | 0.727 | 0.643 | 0.802 | 0.856 | 66.84 | 33.83 |
| | Moderate | 121 | 0.707 | 0.621 | 0.783 | 0.841 | 66.50 | 31.64 |
| | Hard | 118 | 0.710 | 0.626 | 0.787 | 0.836 | 67.22 | 35.45 |
| NBFNet | Easy | 102 | 0.591 | 0.466 | 0.684 | 0.819 | 52.98 | 25.81 |
| | Moderate | 106 | 0.576 | 0.452 | 0.667 | 0.799 | 54.83 | 27.05 |
| | Hard | 104 | 0.578 | 0.454 | 0.671 | 0.801 | 53.52 | 26.90 |

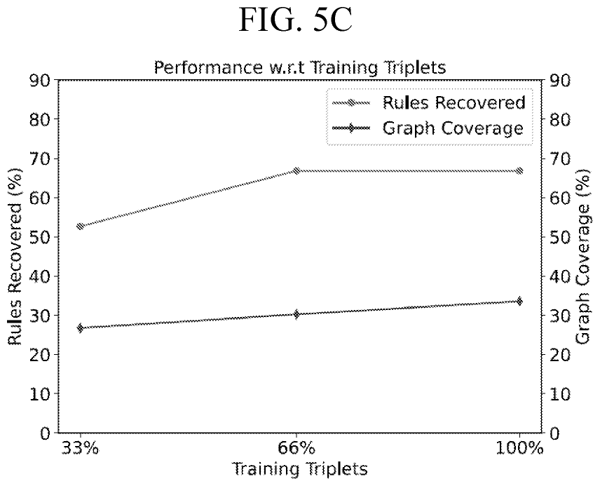

Also, as shown in FIGS. 5A, 5B and 5C, RNNLogic is able to recover two-thirds of the logic rules, whereas NBFNet can only recover a little more than half of the logic rules. However, the graph coverage is low in both cases. Best logic rules inference metrics are achieved by hard GraphLog datasets in RNNLogic with 67.22% of the logic rules recovered and 35.45% graph coverage.

In addition, for NBFNet, the moderate dataset is able to recover 54.83% of the logic rules and had a graph coverage of 27.05%. As can be seen, these results are not consistent with the link prediction metrics where easy datasets performed the best. Even in situations where the models exhibit high link prediction metrics, Graph Coverage remains fairly low. Since Rules Recovered is still fairly high, it can be concluded that both the models miss rules that are important for higher coverage. Further, measuring how Rules Recovered changes with respect to various parameters, is described below.

Regarding performance with respect to top-k rules sampled, FIG. 5A demonstrates the number of rules recovered per top-k sorted sampled rules extracted based on the prior probability computed by the rule generator. RNNLogic is explicitly modeled to learn logic rules, therefore it has better chances of generating high-quality rules. For the same reasons, the percentage of rules recovered saturates after sampling of the top-2000 rules. NBFNet, on the other hand, is only able to recover about half of the underlying ground truth rules as NBFNet is not trained to explicitly learn rules as part of its training.

Regarding performance with respect to the number of rules sampled per relation, the number of recovered logic rules in RNNLogic varies when the number of rules sampled is changed during training. The results presented in FIG. 5B show that the RNNLogic consistently recovers a high percentage of logic rules when the number of rules sampled during training is varied, but the graph coverage remains low.

Regarding performance with respect to the number of training triplets, RNNLogic is data robust, as demonstrated by the consistent number of rules recovered and graph coverage when training the algorithm with 66% or 100% of the triplets, as shown in FIG. 5C.

According to an embodiment, the method of the AI device 100 can include deploying or transmitting the link prediction algorithm when the rules recovered (RR) metric is greater than or equal to the first predetermined threshold (e.g., 66%) and the graph coverage (GC) metric is greater than or equal to the second predetermined threshold (e.g., 33%), but embodiments are not limited thereto. For example, in the above situation regarding evaluation of RNNlogic and the NBFNet, the method can determine to deploy the RNNlogic algorithm over the NBFNet algorithm, since RNNlogic performed better than NBFNet with respect to the rules recovered (RR) metric and the graph coverage (GC) metric.

In addition, an example of the evaluation method using the subjective metrics applied to the logic rules produced by NBFNet is described below.

For example, as discussed above, the method of the AI device 100 can include considering the latest M checkpoints (thus, M sources of link prediction metrics) of each dataset (knowledge graph), and the top-K logic rules based on the model's produced scores can be extracted for evaluation. A metric referred to as quality score (QS) can be used to capture the overall quality of the logic rules generated by a checkpoint (e.g., equation 3).

Further in this example regarding subjective metrics applied to the logic rules produced by NBFNet, the quality of the logic rules are rated on a binary scale, e.g., 0: not useful, 1: useful. Then the 50-top rules of the 5 latest checkpoints were used. Link prediction metrics along with their Quality Scores are shown in Table 2 below, where each dataset metrics originating from 5 different checkpoints along with the Quality Score obtained from the subjective evaluation.

TABLE 2

| | | | | | | Quality |
|---|---|---|---|---|---|---|
| Dataset | MR↓ | MRR↑ | H@1↑ | H@3↑ | H@10↑ | Score↑ |
| ConceptNet | 1529 | 0.078 | 0.039 | 0.081 | 0.161 | 0.538 |
| | 1545 | 0.081 | 0.043 | 0.086 | 0.162 | 0.476 |
| | 1555 | 0.077 | 0.040 | 0.086 | 0.154 | 0.667 |
| | 1558 | 0.077 | 0.040 | 0.084 | 0.149 | 0.644 |
| | 1679 | 0.077 | 0.041 | 0.079 | 0.152 | 0.707 |
| Visual | 15 | 0.336 | 0.205 | 0.375 | 0.612 | 0.735 |
| Genome | 15 | 0.355 | 0.231 | 0.389 | 0.621 | 0.787 |
| | 15 | 0.365 | 0.235 | 0.412 | 0.630 | 0.771 |
| | 15 | 0.394 | 0.231 | 0.394 | 0.616 | 0.771 |
| | 16 | 0.344 | 0.213 | 0.385 | 0.606 | 0.755 |
| ATOMIC | 473 | 0.153 | 0.087 | 0.173 | 0.281 | 0.800 |
| | 474 | 0.155 | 0.086 | 0.169 | 0.290 | 0.740 |
| | 476 | 0.156 | 0.088 | 0.177 | 0.288 | 0.780 |
| | 477 | 0.154 | 0.086 | 0.174 | 0.286 | 0.820 |
| | 483 | 0.154 | 0.087 | 0.175 | 0.278 | 0.680 |

As shown above, the Quality Score remains high regardless of the link prediction metrics, except for when the link predictions are very low. Moreover, Krippendorff's α is found to be 0.3 indicating a fair agreement between the raters (e.g., other levels of agreement 0.41-0.6: moderate, 0.61-0.8: substantial, 0.81-1.0: perfect agreement).

To evaluate the predictive power of the link prediction metrics on the quality of the logic rules, the Predictive Power Score (PPS) can be analyzed across all metrics. For example, both hits@10 and MRR exhibit the highest predictive power, e.g., 0.41 and 0.40 respectively, albeit being not highly predictive of the quality of the logic rules. Therefore, while link prediction metrics have moderate predictive power over the quality of the logic rules, higher link prediction metrics do not translate to the performance in Quality Score. Furthermore, the moderately low agreement among annotators demonstrates logic rule evaluation is a challenging task.

According to another embodiment, the annotators providing the scores can be automatically carried out by predetermined algorithms (e.g., by one or more processors), but embodiments. For example, each of the annotators can correspond to slightly different scoring algorithms (e.g., in which weights or tunning parameters are varied or adjusted).

Thus, as illustrated in the example discussed above, link prediction metrics may not correlate with the quality of the logic rules. In other words, just because a link prediction model exhibits high link prediction metrics, the logic rules recovered by the model may not lead to high graph coverage. According to an embodiment, the method of the AI device 100 can better evaluate a link prediction model using metrics other than link prediction metrics or in addition to link prediction metrics, in order to provide comprehensive evaluation of logic rules produced by a link prediction model.

According to an embodiment, a method of the AI device 100 can include obtaining a knowledge graph, training or learning a link prediction algorithm or model on the knowledge graph, extracting logic rules based on the knowledge graph and the trained link prediction algorithm, and generating metrics for evaluating the logic rules and the trained link prediction algorithm.

Also, the method can include comparing the evaluation metrics to predetermined thresholds or to other evaluation metrics, in order to determine whether to deploy the trained link prediction algorithm and/or select the link prediction algorithm over the other link prediction algorithms. In addition, the trained link prediction algorithm can be saved in the AI device 100 itself for deployment or transmitted to an external device. Further, the trained link prediction algorithm can be deployed in a recommendation system or a question and answering system.

According to an embodiment, the AI device 100 can be configured to answer user queries and/or recommend items (e.g., home appliance devices, mobile electronic devices, movies, content, advertisements or display devices, etc.), options or routes to a user. The AI device 100 can be used in various types of different situations.

According to one or more embodiments of the present disclosure, the AI device 100 can solve one or more technological problems in the existing technology, such as providing comprehensive evaluation of logic rules in knowledge graphs (KGs) and their corresponding link prediction algorithms, and can be used to select or determine a link prediction algorithm.

Various aspects of the embodiments described herein can be implemented in a computer-readable medium using, for example, software, hardware, or some combination thereof. For example, the embodiments described herein can be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure. Also, the embodiments such as procedures and functions can be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

Furthermore, although some aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM.

Computer programs based on the written description and methods of this specification are within the skill of a software developer. The various programs or program modules can be created using a variety of programming techniques. For example, program sections or program modules can be designed in or by means of Java, C, C++, assembly language, Perl, PHP, HTML, or other programming languages. One or more of such software sections or modules can be integrated into a computer system, computer-readable media, or existing communications software.

Although the present disclosure has been described in detail with reference to the representative embodiments, it will be apparent that a person having ordinary skill in the art can carry out various deformations and modifications for the embodiments described as above within the scope without departing from the present disclosure. Therefore, the scope of the present disclosure should not be limited to the aforementioned embodiments, and should be determined by all deformations or modifications derived from the following claims and the equivalent thereof.

What is claimed is:

1. A method for controlling an artificial intelligence (AI) device, the method comprising:
obtaining, via a processor in the AI device, a knowledge graph;
training, via the processor, a link prediction model on the knowledge graph to generate a trained link prediction model;
extracting, via the processor, logic rules from the trained link prediction model;
generating, via the processor, at least one evaluation metric based on the logic rules;
generating, via the processor, an evaluation result based on comparing the at least one evaluation metric to a predetermined criteria; and
outputting, via an output unit in the AI device, the evaluation result.

2. The method of claim 1, further comprising:
saving the trained link prediction model in a memory of the AI device for deployment or transmitting the trained link prediction model to an external device for deployment, based on the evaluation results.

3. The method of claim 2, wherein the trained link prediction model is deployed in a question and answer system or a recommendation system.

4. The method of claim 1, wherein the generating the at least one evaluation metric includes:
generating a rules recovered metric, the rules recovered metric being a value based on dividing a number of the logic rules by a total number of original logic rules for the knowledge graph; and
generating a graph coverage metric, the graph coverage metric being a value based on dividing a number of grounded paths covered by the logic rules by a total number of ground paths for the knowledge graph.

5. The method of claim 4, further comprising:
comparing the rules recovered metric to a first predetermined threshold;
comparing the graph coverage metric to a second predetermined threshold; and
in response to the rules recovered metric being greater than or equal to the first predetermined threshold and the graph coverage metric being greater than or equal to the second predetermined threshold, saving the trained link prediction model in a memory of the AI device for deployment or transmitting the trained link prediction model to an external device for deployment.

6. The method of claim 1, wherein the generating the at least one evaluation metric includes:
receiving a plurality of scores for each logic rule among the logic rules, the plurality of scores being assigned by a plurality of annotators; and
generating one quality score for the logic rules based on a sum of the plurality of scores and based on dividing by a total number of the logic rules.

7. The method of claim 6, wherein each of the plurality of scores is a binary value of 1 or 0.

8. The method of claim 6, further comprising:
comparing the one quality score to a third predetermined threshold; and
in response to the one quality score being greater than or equal to the third predetermined threshold, saving the trained link prediction model in a memory of the AI device for deployment or transmitting the trained link prediction model to an external device for deployment.

9. The method of claim 1, further comprising:
generating link prediction metrics based on the trained link prediction model, the link prediction metrics including at least one of mean rank (MR), mean reciprocal rank (MRR), and Hit@K; and
determining whether to deploy the trained link prediction model based on the link prediction metrics.

10. The method of claim 1, wherein the AI device includes at least one of a smart television, a mobile phone, and a home appliance device.

11. An artificial intelligence (AI) device for providing recommendations, the AI device comprising:
a memory configured to store knowledge graph information; and
a controller configured to:
obtain a knowledge graph,
train a link prediction model on the knowledge graph to generate a trained link prediction model,
extract logic rules from the trained link prediction model,
generate at least one evaluation metric based on the logic rules,
generate an evaluation result based on comparing the at least one evaluation metric to a predetermined criteria, and
output the evaluation result.

12. The AI device of claim 11, wherein the controller is further configured to:
save the trained link prediction model in the memory of the AI device for deployment or transmit the trained link prediction model to an external device for deployment, based on the evaluation results.

13. The AI device of claim 12, wherein the trained link prediction model is deployed in a question and answer system or a recommendation system.

14. The AI device of claim 11, wherein the controller is further configured to:
generate a rules recovered metric, the rules recovered metric being a value based on dividing a number of the logic rules by a total number of original logic rules for the knowledge graph, and
generate a graph coverage metric, the graph coverage metric being a value based on dividing a number of grounded paths covered by the logic rules by a total number of ground paths for the knowledge graph.

15. The AI device of claim 14, wherein the controller is further configured to:
compare the rules recovered metric to a first predetermined threshold,
compare the graph coverage metric to a second predetermined threshold, and
in response to the rules recovered metric being greater than or equal to the first predetermined threshold and the graph coverage metric being greater than or equal to the second predetermined threshold, save the trained link prediction model in the memory of the AI device for deployment or transmit the trained link prediction model to an external device for deployment.

16. The AI device of claim 11, wherein the controller is further configured to:
receive a plurality of scores for each logic rule among the logic rules, the plurality of scores being assigned by a plurality of annotators, and
generate one quality score for the logic rules based on a sum of the plurality of scores and based on dividing by a total number of the logic rules.

17. The AI device of claim 16, wherein each of the plurality of scores is a binary value of 1 or 0.

18. The AI device of claim 16, wherein the controller is further configured to:
compare the one quality score to a third predetermined threshold, and
in response to the one quality score being greater than or equal to the third predetermined threshold, save the trained link prediction model in the memory of the AI device for deployment or transmit the trained link prediction model to an external device for deployment.

19. The AI device of claim 11, wherein the controller is further configured to:
generate link prediction metrics based on the trained link prediction model, the link prediction metrics including at least one of mean rank (MR), mean reciprocal rank (MRR), and Hit@K, and
determine whether to deploy the trained link prediction model based on the link prediction metrics.

20. A method for controlling an artificial intelligence (AI) device, the method comprising:
obtaining, via a processor in the AI device, a knowledge graph;
training, via the processor, a link prediction model on the knowledge graph to generate a trained link prediction model;
extracting, via the processor, logic rules from the trained link prediction model;
generating, via the processor, a rules recovered metric by dividing a number of the logic rules by a total number of original logic rules for the knowledge graph;
generating, via the processor, a graph coverage metric by dividing a number of grounded paths covered by the logic rules by a total number of ground paths for the knowledge graph; and
outputting the rules recovered metric and the graph coverage metric.
